(19) United States
(12) Patent Application Publication
(10) Pub. No.: US 2005/0184853 A1
(43) Pub. Date: Aug. 25, 2005

(54) Information security

(76) Inventors: Roger A Payne, Ipswich (GB); Peter j Brown, Ipswich (GB); Christopher S Ormston, Ipswich (GB); Andrew J Garrett, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/511,904

(22) PCT Filed: May 2, 2003
(86) PCT No.: PCT/GB03/01873

(30) Foreign Application Priority Data
May 3, 2002 (EP) 02253141.2

(51) Int. Cl. H04B 1/00

(52) U.S. Cl. 340/5.2; 340/5.73; 340/5.74; 713/200

(57) ABSTRACT

A personal computer (2) is responsive to the presence of an authorised user to transmit release signals from a CPU 22 to a CPU 28 to cause the CPU 28 to effect the release of a locking mechanism (34) controlling access to drawers of a desk or filing cabinet for example. In the absence of periodic refresher signals from the PC 2, the CPU 28 causes the locking mechanism to lock the drawers to prevent unauthorized access. The transmitted signals from the PC 2 may also be used to prevent or allow use of electrical or electronic apparatuses and/or to control environmental conditions appropriate to the presence or absence of users.

The present invention relates to information security and more particularly to an automated office environment which enhances the security of physical and data files stored therein.

The majority of office environments now have near per person access to a desk top computer or a lap-top computer associated with a docking device which automatically effects connection to a local area network or a similar communications channel.

In most offices each computer user will also have a number of filing cabinets or desk drawers to which access is required during the time at which that person is working in the environment. The problem is that each individual item of office furniture and/or equipment to which the user requires access needs to be unlocked using a different access mechanism. Thus for computers a pass word or PIN is required while desk drawers and filing cabinets may have keys or combination locks.

Accordingly on arrival at the office it is necessary for each of the items to be individually accessed and on departure from the office each requires to be individually secured. In particular, this can result in a security lapse in so far as an individual may forget to lock drawers etc on departure from the office and may be inclined to take the risk of leaving everything accessible during short duration absence from the office area.

According to the present invention there is provided an information security system comprising a computer system responsive to the presence of an identifiable entity to permit access to the computer system and to transmit signals to at least one other linked locking mechanism to cause said locking mechanism to release whereby access controlled by said at least one other locking mechanism is specifically permitted while said computer system is validly accessible.

Preferably the locking mechanism includes timing means which in the absence of periodic release signals inhibits access after a predetermined time period expires.

A plurality of locking mechanisms each controlling access to a respective entity may be provided, at least some of said entities comprising lockable physical objects such as drawers, doors or windows. Some other of said entities may comprise electronic or electrical equipments whereby use of such electronic or electrical equipments is only permitted while an authorised user is present.

Such electronic or electrical equipments may include printers, photocopiers and scanners for example. The locking mechanism may also control usage of communication lines whereby telephony or facsimile transmission may be inhibited in the absence of an appropriately authorised user or whereby such facilities my be limited in there usage to prevent certain categories of call or communication.

Shared facilities such as printers may be responsive to signals from a plurality of computers each responsive to a respective identifiable entity. Some locking mechanisms may also be responsive to signals from an alternative source to permit access without requiring access to a computer of the system.

In one arrangement controlling computers include low power radio transmission arrangements whereby following authorised access to such a computer causes periodic transmission of coded release signals whereby correspondingly coded radio transmission receivers linked to respective locking mechanisms provide release instructions to respective locking mechanisms.

The transmission of release signals from a computer may be inhibited if the computer enters a temporary inhibition of access such as when the computer enters a screen saver mode in the absence of entry of data thereto. The release signals may continue if the presence of an authorised entity is detected.

According to a feature of the present invention there is provided an office environment comprising at least one computer and at least one linked lockable device, the computer being responsive to an authorised identifiable entity to effect unlocking of the lockable device to permit access to the device while said identifiable entity is present.

A security system and an office environment including such a system will now be described by way of example only with reference to the accompanying drawings of which:—

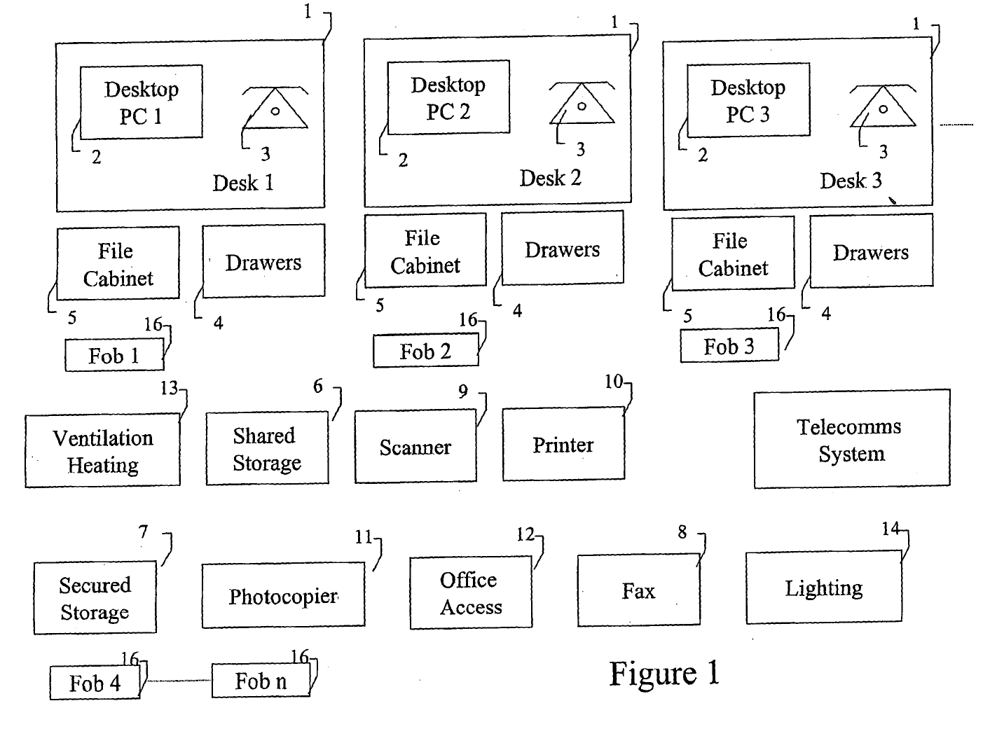

FIG. 1 is a schematic representation of an office and apparatus therein;

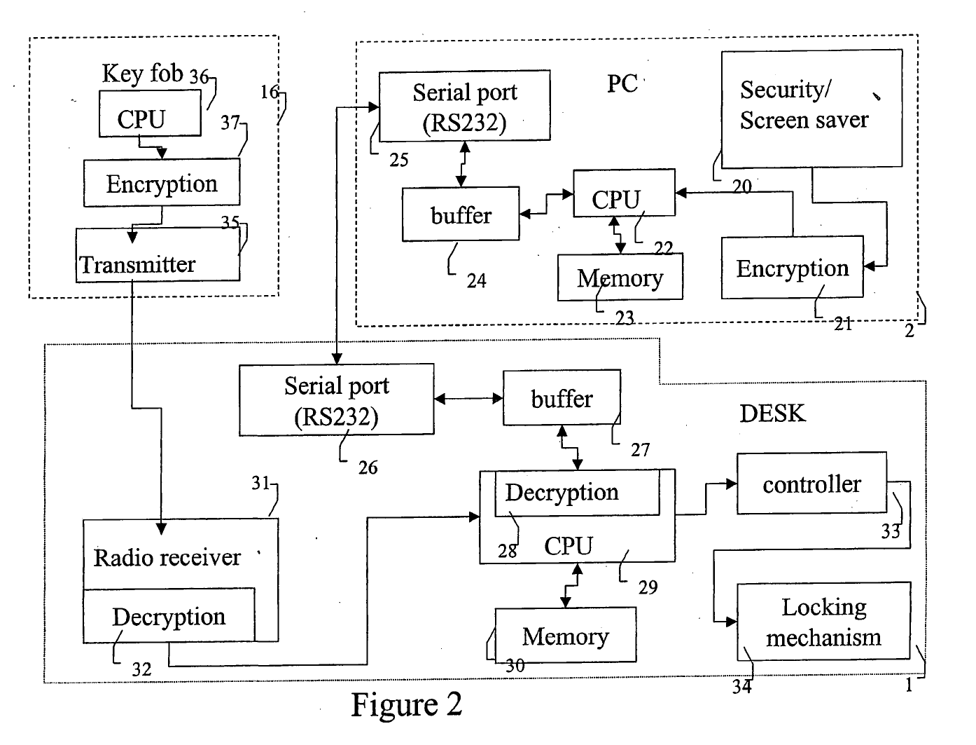

FIG. 2 is a block schematic diagram of the system used in the office of FIG. 1; and

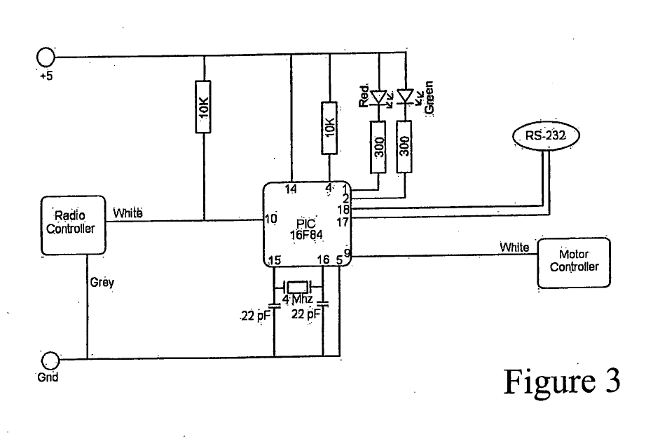

FIG. 3 is a circuit diagram of a locking mechanism associated with the system of FIG. 2.

Referring first to FIG. 1, A typical office will have a number of desks 1, only three of which are shown for simplicity. Each desk 1 will have an associated desktop computer 2, one or more telephones 3 and drawers 4. The office environment may also include filing cabinets 5 for personal use by desk users. Many offices will also include shared filing storage 6, 7 and shared office facilities such as a fax machine 8, scanner 9, printer 10 and photocopier 11.

In addition to the above it may be necessary to control access (12) to the office for example through secured doors, to ensure that ventilation through opening windows is also controlled (13) and there may be a desire to control heating and ventilation through common control arrangement. Control of lighting may (14) for economy and safety may also be desirable. In general the telecommunications system 15 providing service to the telephones 3 can also be controlled through usage of the computers 2.

Access to PC's 2 and/or other office entities including but not necessarily limited to those shown as items 3 to 14 is by way of an identifier. This may be a password protection arrangement through access to one of the computers 2 or by way of some other physical security arrangement associated with an individual, for example proximity detection or swipe cards, retina scan or other bio-scanning control here schematically represented as fobs “1−n” 16.

Turning now to FIG. 2, in one implementation of the invention, a desktop personal computer terminal 2 includes a biometric sensor, for example a fingerprint detector, connected to its parallel port for example. Individual user's fingerprint comparison data is held within memory of the computer so that authorised users can activate the system. The representation of the secure access to the computer (Security 20) also indicates a responsiveness to screen savers which may be keyboard/mouse or timeout selected in known manner. Information from the security access control 20 is encrypted by an encryption device 21 and passed to the central processing unit (CPU) 22 of the PC 2 for comparison with user information stored in the memory 23.

Assuming that data identifying an authorised user is present then the CPU 22 outputs a data stream by way of a buffer 24 to a serial output port 25 which is wired to a corresponding serial port 26 in a secured desk 1. Received data from the CPU 22 is stored in a buffer 27 of the desk 1 and is transferred by way of a decryption device 28 to a respective CPU 29. Again the received data is compared with a user identity held in memory 30 and assuming that a valid identity is received the CPU 29 outputs a signal to a lock controller 33 which sends a release signal to actuate an associated locking mechanism 34. This locking mechanism will release, for example, the respective drawers 4 (FIG. 1) of the desk 1 and may also be hard wired to a respective filing cabinet 5 (FIG. 1) to cause the locking mechanism of that device to be released. The CPU 28 will now start a timer which will cause a lock signal to be sent to the controller 33 after a pre-determined period of time so that in the absence of a further release signal from the CPU 22 the respective drawers and filing cabinet are automatically secured.

Thus the CPU 22, sensing the presence of an authorised individual through biometric sensing or user activity, periodically transmits a release signal to the buffer 24 and serial port 25 to retain associated apparatus in a released condition. For the avoidance of doubt it is here noted that a positive locking signal may also be transmitted by the CPU 22 to the CPU 29 whereby in the absence of a user for a pre-determined period of time, such as set for activation of a screen saver in known manner, or in response to user input requesting such activation, associated drawers 4 and filing cabinets 5 are secured.

To enable the drawers 4 of the desk 1 to be released without the need for activating the PC, a radio receiver 31 with an associated decryption device 32 is also provided. The radio receiver 31 is responsive to signals received from a transmitter 35 incorporated in a key fob 16 which includes a CPU 36 and encryption device 37. Such key fobs are known, for example for the purposes of locking and unlocking vehicles. Thus the CPU 29 is responsive to unlocking signals transmitted from the fob 16 to effect unlocking of the drawers 4 associated with the individual registered to the key fob as determined by data held in the memory 30. The CPU 29 will respond to key fob activation in the same way as if an unlocking signal had been received from the PC 2, that is it will start a timing loop and may require periodic release signals to be transmitted to maintain the drawers 4 in an unlocked state. It will also be appreciated that a lock signal may also be transmitted from the key fob 16 to specifically lock the associated drawers without waiting for the expiry of the timer in the CPU 29. The CPU 29 may have different timing cycles dependent upon the source of the releasing signal, for example expecting a regular repetition at short interval, say fifteen seconds if release and locking is under the control of the PC 2 but having a longer interval, say five minutes, if under the control of the key fob 16. The CPU 29 may be programmed to cause an audible or visual alert a few seconds prior to locking the drawers 4 to remind the user of the need to retransmit a release signal.

FIG. 3 shows a circuit diagram of a locking mechanism based upon a PIC16F84 microprocessor available from RS Components (United Kingdom) (cat No. 328-3747), a radio controller type Remote Receiver CR44X available from Maplin Electronics (United Kingdom) and a motor controller for actuating locking mechanisms. A plurality of motor controllers may of course be controlled for a single microprocessor so that a number of individually lockable drawers may be simultaneously locked or unlocked. Motor driven drawers may be used so that when a locking signal is received the drawers are automatically closed prior to locking. Alternatively a drawer open detector function may be used associated with an appropriate audible or visual alert to remind the user of the need to close drawers to enable locking to take place.

The following short program may be incorporated in the PC 2 to send a Command line parameter out to the serial port:

Start

Get text as command line argument.
Configure serial port.
Open serial port.
For each character in the text in order do

{Send the character out the serial port.
Pause.}.

Close serial port.

Stop

The above is simplified for the purposes of description and adaptations and improvements will be apparent to the reader. Some items which are readily included facilitate storage and receipt of the text (including the pass code) in an encrypted format (as noted above), inclusion of user definable settings (stored for example in a file or registry or passed as command line arguments) for the serial port and the length of delay between characters.

The system will of course include an appropriate graphical user interface (GUI) to simplify entry and editing of user codes and settings, possibly also to be used for defining entries of the identity of devices and office entities associated with the authorised users.

The PIC 16F84 Pseudo Code for the lock control arrangement of FIG. 3 is as follows:

MAIN ( )
{

SET ALL PORTS TO A KNOWN STATE
INITILISE ARRAY
SETUP ALL VARIABLES

LOOP:

WHILE (FILLING ARRAY)
{

BUFFER = RS-232 INPUT
IF (BUFFER = ‘X’)
{

SEND RS-232 ‘STATE OF DRAWERS’

}
ELSE IF (BUFFER NOT IN RANGE 0-9)
{

SEND RS-232 ‘OUT OF RANGE’

}
ELSE
{

ARRAY[X] = BUFFER
X + +

}

}
IF (ARRAY = UNLOCK CODE)
{

UNLOCK DRAWERS

}
ELSE
{

LOCK DRAWERS

}
RESET ARRAY COUNTER
CLEAR ARRAY
GOTO LOOP

}
ISR ( )
{

IF (DRAWERS LOCKED)
{

UNLOCK DRAWERS

}
ELSE
{

LOCK DRAWERS

}

}

Having discussed the basic implementation of a security arrangement in accordance with the invention, further usage of the system will now be discussed with reference to FIG. 1 in particular. For the purposes of the following discussion, the communication link between the PCs 2 and the other entities, rather than being directly wired between ports may be of another kind such as a short range encoded radio linking. Thus the release and lock signals may be transmitted from the PC 2 and each office apparatus may include an appropriate radio receiver responsive to appropriately coded signalling messages to activate.

Certain devices may be responsive to the presence of any authorised user release signal to be operable. Thus if any authorised user is present shared storage cabinets 6 may be unlocked, the scanner 9, printer 10, photocopier 11 and fax machine 8 may be activated so that any user may utilize them within the environment. This may have the additional advantage that such equipments will only operate in their correct location, that is in the vicinity of authorised user terminals, so that theft of the equipment and/or unauthorised usage is inhibited.

Environmental conditioning devices may also be responsive to presence or absence of users. For example, a lighting controller 14 may be responsive to signals from a PC 2 associated with a particular one of the desks 1 to switch on lighting units appropriate to that desk area and to control lighting on emergency exit routes and common areas whereby a measure of additional energy efficiency can be achieved.

Office security may be enhanced by ensuring that access doors are only accessible to authorised entrants and may restrict access to some people unless certain other authorised individuals are present. Ventilation and heating may also be controlled such that in the absence of users a lower or higher office temperature may be acceptable reducing the need for air conditioning and/or heating to be active.

Further security improvements may include controlling opening windows so that only in the presence of a user can windows be opened for additional ventilation.

In another enhancement some filing cabinets or other apparatus may be controlled such that only in the presence of specific persons is common access provided. Thus the secured storage 7 may be programmed so that only if two (or more) authorised individuals selected from a group of authorised individuals is present is access permitted to that storage. The number of authorised users required to be present can be set by an office controller and there may be selectable overrides in respect of for example “if either A or B&C or B&D&E” are present the secured storage may be unlocked. Any Boolean logical combination could be used.

In an additional facility, by linking the release code information to an office telecommunications system either directly or by messaging, the facilities provided to each telephone 3 and the fax 8 for example may also be controlled. Thus the telephones 3 may have their access to external calling restricted to emergency calls only, to local calls only, to national calls only or be freely usable for any calling pattern. Accessible telephone numbers allowed to be dialled by individual users can therefore be controlled in dependence upon the users authorisation level. This link can also be used to direct telephony to the users desk in dependence upon the authorised user present.

Thus in a “hot desking” arrangement, some of the desks 1 may be available to non-specific users respectively identified by their own fob 16. Accordingly when one of the PCs 2 is activated and the individual is identified then respective filing cabinet/drawer access can be granted and the telecommunications system 15 can be notified of the user's identity and location such that incoming calls for the particular user are appropriately directed and an appropriate level of authorisation for effecting outgoing calls and/or for providing users abbreviated dialling facilities may be activated.

The features described above are exemplary and should not be taken as indicating the only way in which the integrated office environment can be achieved. Thus the invention may be applied to virtually any electrical or electronic apparatus and to any lockable furniture. This ensures that only authorised users may use the apparatus or have access to the contents of the furniture. Flexibility of the working environment is achieved so that multiple users may be individually identified and allowed appropriate access to their own papers and or to their own computer programmes and storage. Environmental controls appropriate to the occupancy of the integrated office environment may also be implemented.

In order to ensure that the system described above always “fails safe”, it is expected that the locking system will normally default to lock mode in the event of computer power failure. In respect of the desktop locking system hereinbefore described which requires periodic refreshment of the lock release signalling, if the main desktop computer fails automatic locking will occur after the heartbeat timer of the subsidiary microprocessor ceases.

It will be realised that emergency access/egress routes and lighting should not be locked in the egress direction if a failure occurs. To enable drawer closure motors (where fitted) and locks to operate the desktop units will incorporate a back up battery having sufficient power to provide at least a single lock action. Alternatively a rechargeable battery may be incorporated as part of the power supply unit associated with the various office entities whereby localised short term power failure does not inhibit usage of the working environment.

For drawers, filing cabinets and other locking entities a manual override system (for example a standard key or combination release) may be provided so that in the event of failure of the electronic locking arrangements appropriately authorised key holders may access the components, turn on lighting, heating, air conditioning and other features.

Where the telecommunication system fails to receive information from the desktop computers (including on power failure) in respect of any of the telephony units it will default to particular numbers programmed for the telephony and/or facsimile units.

1. An information security system comprising a computer system responsive to the presence of an identifiable entity to permit access to the computer system and to transmit signals to at least one other linked locking mechanism to cause said locking mechanism to release whereby access controlled by said at least one other locking mechanism is specifically permitted while said computer system is VALIDLY accessible.

2. An information security system as claimed in claim 1 in which the locking mechanism includes timing means which in the absence of periodic release signals inhibits access after a predetermined time period expires.

3. An information security system as claimed in claim 1 in which a plurality of locking mechanisms each controlling access to a respective entity are provided.

4. An information security system as claimed in claim 1 in which the or at one of said locking mechanisms is associated with a respective lockable physical object.

5. An information security system as claimed in claim 1 in which the or at one of said locking mechanisms is associated with a respective electronic or electrical equipment whereby use of such electronic or electrical equipment is only permitted while an authorised user is present.

6. An information security system as claimed in claim 1 in association with telecommunications control means arranged to control usage of communication lines whereby telephony or facsimile transmission may be inhibited in the absence of an appropriately authorised user.

7. An information security system as claimed in claim 1 in association with telecommunications control means arranged to control usage of communication lines whereby telephony or facsimile transmission is limited in usage to prevent certain categories of call or communication.

8. An information security system as claimed in claim 1 including shared facilities responsive to signals from a plurality of computers each responsive to a respective identifiable entity to permit usage of such shared facilities.

9. An information security system as claimed in claim 1 in which the or each locking mechanism is also responsive to signals from an alternative source to permit access without requiring access to a computer of the system.

10. An information security system as claimed in claim 1 in which the locking mechanism is in wired communication with the controlling computer.

11. An information security system as claimed in claim 1 in which the or each controlling computer includes radio transmission arrangements whereby following authorised access the computer causes periodic transmission of coded release signals whereby correspondingly coded radio transmission receivers linked provide release instructions to respective locking mechanisms.

12. An information security system as claimed in claim 11 in which the transmission of release signals from a computer may be inhibited if the computer enters a temporary inhibition of access.

13. An information security system as claimed in claim 12 in which the transmission of release signals is inhibited in the absence of entry of data thereto for a predetermined period.

14. An information security system as claimed in claim 1 in association with an environmental control arrangement whereby at least one of lighting, heating and ventilation are controlled in dependence upon the presence or absence of one or more users.

15. An information security system as claimed in claim 1 in which at least one of said locking mechanisms requires the presence of more than one authorised individual.

16. An information security system as claimed in claim 1 in which the computer system is linked to a telecommunications system and transmits information defining the identity of the authorised user present whereby associated telephony devices receive facilities and communications appropriate to the respective identified authorised user.

17. An office environment comprising at least one computer and at least one linked lockable device, the computer being responsive to an authorised identifiable entity to effect unlocking of the lockable device to permit access to the device while said identifiable entity is present.
